(19) United States
(12) Patent Application Publication
(10) Pub. No.: US 2007/0017395 A1
(43) Pub. Date: Jan. 25, 2007

(54) Method and apparatus for uniformly heating a substrate

(76) Inventors: Joel D. Neri, Youngstown, NY (US); Pamela A. Geddes, Alden, NY (US); Jim Ibarra, Williamsville, NY (US); Daniel J. Harrison, Pittsford, NY (US)

Correspondence Address: HOWARD J. GREENWALD P.C., 349 W. COMMERCIAL STREET SUITE 2490, EAST ROCHESTER, NY, 14445-2408, US

(21) Appl. No.: 11/490,392

(22) Filed: Jul. 20, 2006

Related U.S. Application Data
(60) Provisional application No. 60/702,067, filed on Jul. 22, 2005.

(51) Int. Cl. B41F 35/00

(52) U.S. Cl. 101/424.1; 438/795

(57) ABSTRACT

Disclosed in this specification is a method and apparatus for uniformly heating a substrate, comprising the steps of disposing a substrate over heating elements, irradiating the bottom side of the substrate, thus producing a non-uniformly heated substrate. Thereafter the transporter moves the substrate such that the unheated sections are disposed over heating element and heated sections are disposed over the transporter. The substrate is then re-irradiated such that the unheated section becomes uniformly heated. Heat is allowed to radiate from the bottom side to the top side of the substrate, such that the top side achieves a uniform temperature.

### CROSS-REFERENCE TO RELATED PATENT APPLICATIONS

This application claims the benefit of the filing date of U.S. provisional patent application U.S. Ser. No. 60/702,067 filed Jul. 22, 2005. The entire content of the above referenced patent application is hereby incorporated by reference into this specification.

### FIELD OF THE INVENTION

This invention relates to the uniform heating of substrates and, in one embodiment, to the cycling or shuttling of the substrate over heating elements in a manner that promotes uniform heating. Such a heating process is particular useful for the application of images to ceramic or glass substrates, as highly uniform temperatures are often desirable to ensure high image quality.

### BACKGROUND OF THE INVENTION

The heat transfer of a digital ceramic image from a decal to a substrate can be accomplished if facilitated by a thermally activatable adhesive layer which may be incorporated as part of the image or applied to the image by coating, laminating or printing. The printing may be either image wise (i.e. only over selected portions) or flood over (i.e. over the entire surface) some or all of the decal surface. Beyond simple transfer of the digital ceramic image to the substrate, the image needs to be positioned on the substrate according to the design specification provided by the customer. This can be accomplished with a decal positioning and heat lamination system, herein, called the IPS (Image Positioning System).

Lamination of films to rigid substrates is well known in the art. For example, U.S. Pat. No. 2,673,163 discloses a glass roller apparatus for laminating plastic films to glass substrates the production of safety glass. Newer methods of safety glass lamimation utilize Autoclave technology, such as those disclosed in U.S. Pat. No. 6,726,979. A process for preparing a ceramic decal is described in U.S. Pat. No. 6,481,353. In this patent two methods are described for heat transferring the image from the decal to the substrate. On such process utilizes a hot silicone pad to selectively pick the image off the decal and transfer it to the substrate. The other process requires a special heat transfer paper decal containing a meltable wax release layer. U.S. Pat. No. 6,629,792 describes the transfer of a frosted ink layer from a decal to a glass substrate utilizing a heat press to bond the frosted ink layer to the glass.

The methods described in the prior art of accurately and uniformly transferring an image from a decal to a rigid substrate have been found to be inadequate. In the instant invention it has been found that waxy release layers, such as those disclosed in U.S. Pat. No. 6,481,353 do facilitate heat transfer of an image to a substrate. However, such decals are difficult to digitally print on, with the wax layer often separating from the decal backing sheet before the printing of the digital image is complete. Using a heat press, such as the one described in U.S. Pat. No. 6,629,792, does not generate sufficient pressure to remove all the air from between the decal and the glass, leaving air bubble after pressing. Autoclave systems, such as the one described in U.S. Pat. No. 6,726,979 over come this problem. However, these devices require very high pressure vessels and are thus very expensive. Roller lamination, as disclosed in U.S. Pat. No. 2,672,168, can generate sufficient lamination pressure to eliminate air bubbles. However, uniform heating of the composite is necessary for accurate and complete image transfer. U.S. Pat. No. 2,672,168 does not disclose how to uniformly heat the composite, only that it may be heated. U.S. Pat. No. 5,337,363 discloses a method to heat a glass substrate, but does not disclose how to uniformly laminate a decal to the heated substrate.

It is an object of this invention to provide a method for uniformly heating a substrate.

It is an object of this invention to provide a method and/or apparatus for transferring an image to a uniformly heated substrate, preferably with a decal, thus producing an imaged substrate.

### SUMMARY OF THE INVENTION

In accordance with the present invention, there is provided a method and apparatus for uniformly heating a substrate, comprising the steps of disposing a substrate over heating elements, irradiating the bottom side of the substrate, thus producing a non-uniformly heated substrate. Thereafter the transporter moves the substrate such that the unheated sections are disposed over heating element and heated sections are disposed over the transporter. The substrate is then re-irradiated such that the unheated section becomes uniformly heated. Heat is allowed to radiate from the bottom side to the top side of the substrate, such that the top side achieves a uniform temperature.

The technique described above is advantageous because it is significantly simpler than prior art methods for heating substrates. The technique is also advantageous in that the more uniform temperature results in a higher quality imaged substrate.

### BRIEF DESCRIPTION OF THE DRAWINGS

The invention will be described by reference to the following drawings, in which like numerals refer to like elements, and in which:

FIG. 1 is a flow diagram of one process of the invention;

FIG. 2 is a schematic illustration of one apparatus for performing the process of FIG. 1;

FIG. 3 is a depiction of the positioning of a decal on a substrate using tape;

FIG. 4 is a schematic diagram of the in-feed conveyor of FIG. 2;

FIG. 5 shows one heating apparatus for use with the present invention;

FIG. 6 is an illustration of the heating conveyor of FIG. 2;

FIG. 7 is a diagram of the laminator assembly of FIG. 2;

FIG. 8 depicts the cooling conveyor of FIG. 2;

FIG. 9A and FIG. 9B depict one shuttling method to uniformly heat a substrate;

FIG. 9C is a flow diagram of one process of the present invention;

FIG. 10A and FIG. 10B show another shuttling method of the present invention;

FIG. 10C and FIG. 10D show the remaining steps in the shuttling process;

FIG. 11A and FIG. 11B show another shuttling method of the present invention;

FIG. 11C and FIG. 11D show the remaining steps in the shuttling process;

FIG. 12A and FIG. 12B depict one shuttling method to uniformly heat a substrate;

FIG. 13A and FIG. 13B show another shuttling method of the present invention;

FIG. 13C and FIG. 13D show the remaining steps in the shuttling process;

FIG. 14A and FIG. 14B show another shuttling method of the present invention;

FIG. 14C shows the remaining steps in the shuttling process;

FIG. 15 is a partial view of another image positioning system for use with the present invention; and

FIG. 16 is another partial view of the image positioning system tray of FIG. 15.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENTS

For a general understanding of the present invention, reference is made to the drawings. In the drawings, like reference numerals have been used throughout to designate identical elements.

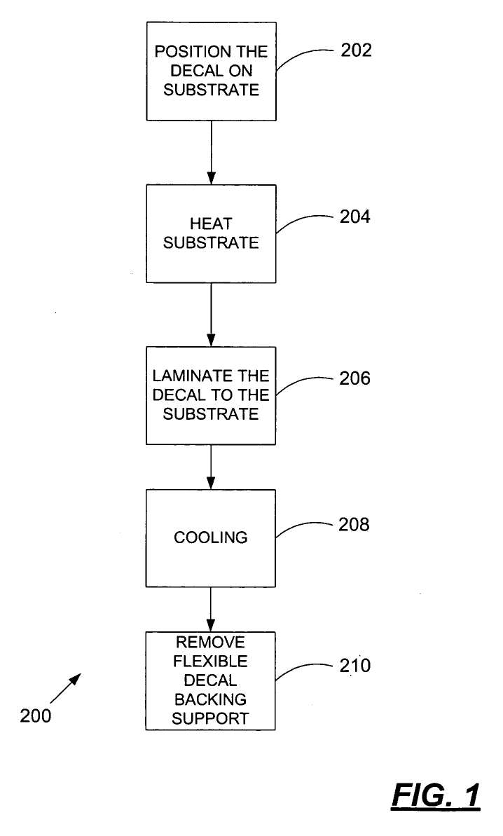

As illustrated in the flow diagram shown in FIG. 1, the Image Positioning System (IPS) process 200 is comprised of the steps of positioning the decal on the substrate (step 202), heating the substrate (step 204), laminating the decal to the substrate (step 206), cooling the image and substrate (step 208) and removing the flexible decal backing support (step 210). It should be appreciated that the aforementioned steps may be performed in an alternate order. For example, step 204 (heating substrate) may take place prior to step 202 (positioning the decal on the substrate). In another embodiment, the step of heating the substrate (step 204) and the step of laminating the decal to the substrate (step 206) are performed substantially simultaneously.

One Assembly for Performing Process 200

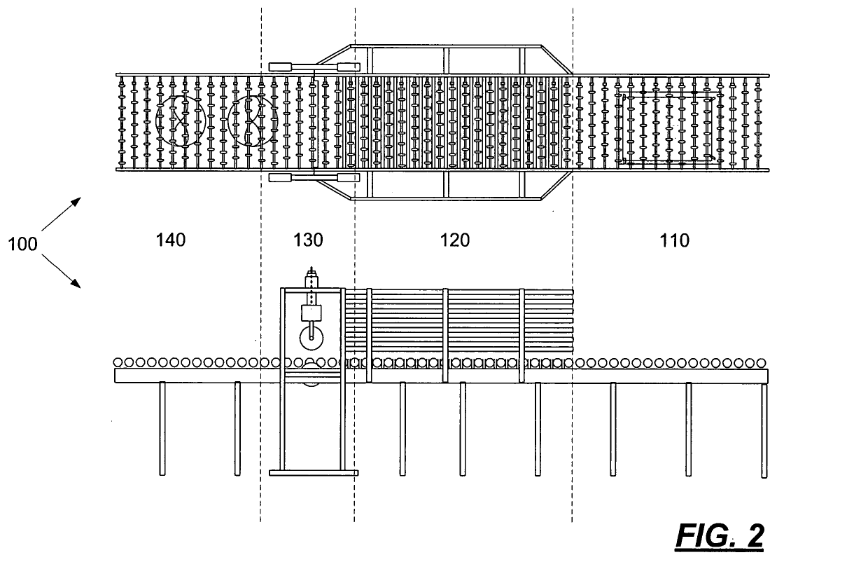

FIG. 2 is a depiction of image positioning system (IPS) 100 that performs process 200. The IPS 100 is divided into four sections: the in-feed conveyor 110 (wherein step 202 is performed), the heating conveyor 120 (wherein step 204 is performed), the nip/laminator assembly 130 (wherein step 206 is performed) and the cooling conveyor 140 (wherein steps 208 and 210 are performed). Each of these sections, and the steps performed within each section, will now be discussed in greater detail.

Position the Decal on the Substrate

In step 202 of process 200, illustrated in FIG. 1, the decal is positioned on the substrate. It is desirable that the decal be comprised of a heat activatable, pressure adhesive layer. This adhesion layer is configured such that it will adhere to a substrate upon application of at least a certain pressure (referred to as the pressure activation threshold) when the substrate is at least a certain temperature (referred to as the thermal activation threshold). Since both temperature and pressure are needed to cause the decal to adhere, the decal can be repositioned on the substrate while still hot. Such decals are known in the art. Reference may be had, for example, U.S. Pat. Nos. 5,300,170 to Donohoe (Decal Transfer Process); 4,392,905 to Boyd (Method of transferring designs onto articles); 4,557,964 to Magnotta (Heat Transferable Laminate); 6,481,353 to Geddes (Process for Preparing a Ceramic Decal); 6,721,271 and 6,854,386 to Geddes (Ceramic Decal Assembly); 6,990,904 to Ibarra (Thermal Transfer Assembly for Ceramic Imaging); and the like. The content of the aforementioned patents is hereby incorporated by reference into this specification. Such decals promote accurate positioning of the decal. Any suitable means of positioning may be used.

The decal can be placed on the glass either before or after heating (step 204). If placed on the glass before heating, it is desirable to minimize adhesion of the decal to the substrate before lamination step 206. Such a configuration helps to minimize air entrapment. Since the decal may not lay completely flat on the substrate, it should be able to slide across the hot substrate surface without sticking or binding ahead of the lamination nip. In one embodiment the decal is affixed in the correct position over the substrate by hand and then taped in place. The tape can also be used to apply tension to the decal to help keep it flat. Proper tensioning of the decal can help direct wrinkles out of the paper as it is laminated. Alternatively, the decal may be positioned on the substrate after heating using the image positioning tray described elsewhere in this specification.

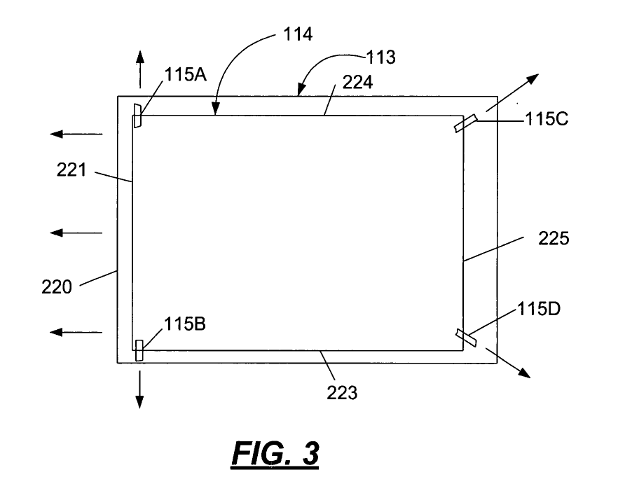

In one embodiment, the decal is manually positioned. One such embodiment is illustrated in FIG. 3 wherein the decal 114 is placed at a predetermined position on substrate 113. In the embodiment depicted, the decal 114 is affixed to the substrate 113 with tape 115A-115D. It is preferred to use tape that will endure high temperatures. Substrate 113 is comprised of a substrate leading edge 220, and the decal 114 is comprised of a decal leading edge 221, both of which are fed into the nip/laminator 130 (not shown in FIG. 3, but see FIG. 2). Decal 114 is also comprised of decal trailing edge 225. In the embodiment depicted, tape 115A-115D is place in such a way so as to prevent buckling of the decal 114 as it is fed through the nip rollers (not shown) of the laminator (not shown) and/or during the heating of the decal 114 and/or substrate 113. In the embodiment depicted in FIG. 3, tape 115A-115D is comprised of four pieces of tape (115A to 115D). Each of these pieces of tape are placed so as to prevent buckling of the decal. Pieces of tape 115A and 115B are placed on decal edge 224 and 223 respectively. As is apparent in FIG. 3, the pieces of tape 115A and 115B are placed so as to create a tension along decal leading edge 221, thus preventing buckling. Similarly, pieces of tape 115C and 115D are placed on decal trailing edge 225 in such a fashion so as to create diagonal tension across decal 114, thus preventing buckling.

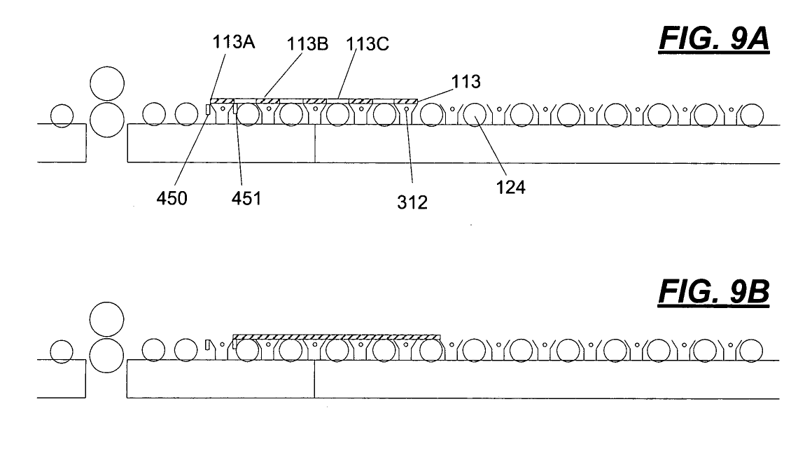

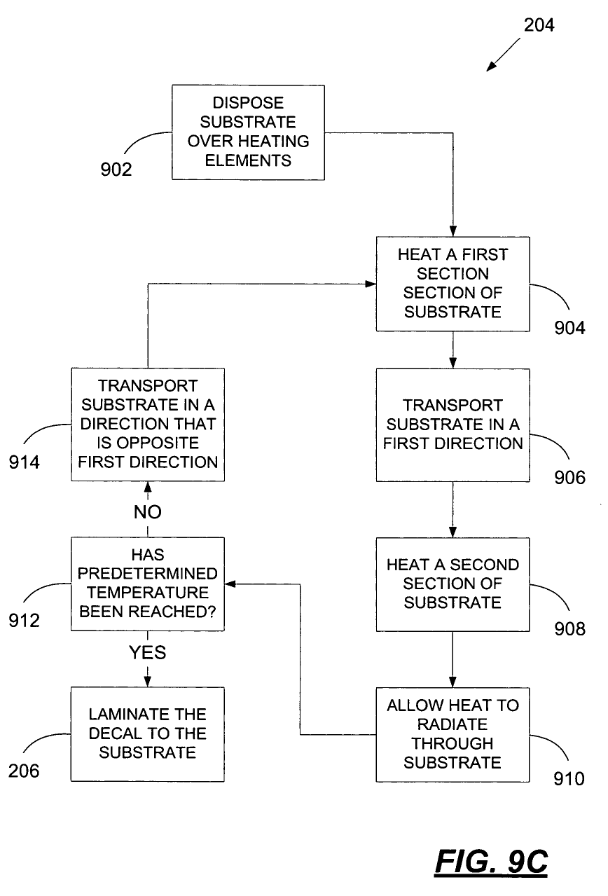

In another embodiment, the decal 114 can be positioned beneath the substrate 113 with tape 115A-115D. It will be recognized by those skilled in the art that in such an arrangement, the decal 114 and substrate 113 can either be heated from below as depicted in FIG. 9A or from above (not shown).

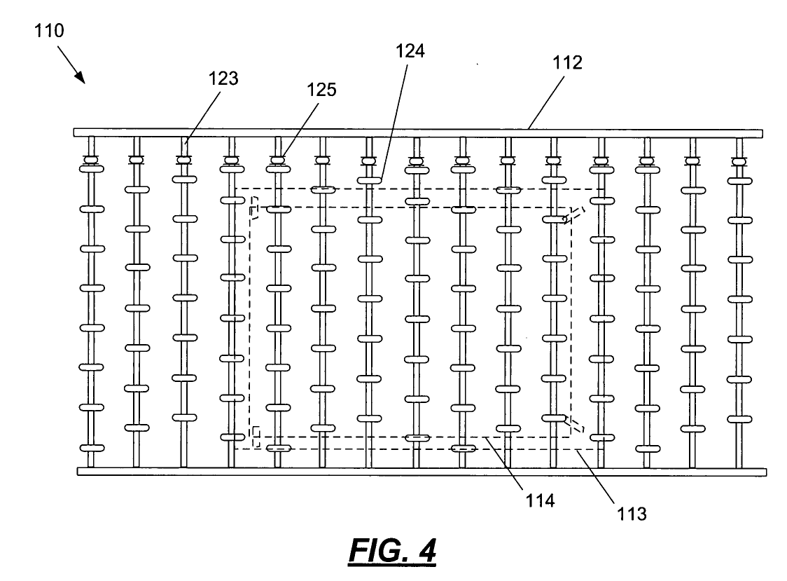

Referring again to FIG. 2, in one embodiment, step 202 is performed in in-feed conveyor 110 of IPS 100. A detailed view of in-feed conveyor 110 is shown in FIG. 4. The substrate 113 (see FIG. 4) is placed on the in-feed conveyer 110. The imaged ceramic decal 114 may then be positioned on substrate 113 according to the specifications provided by the customer. The imaged ceramic decal may then be affixed to the substrate 113 with heat resistant tape 115A-115D (see FIG. 2).

As shown in FIG. 4, the in-feed conveyor 110 is comprised of a set of multiple drive shafts 123 mounted on a frame 112. Each drive shaft 123 is attached to a drive pulley 125. In turn, the drive pulley 125 is attached to a drive motor (not shown) which serves to rotate the drive shaft by translating a rotational force to the drive shaft 123 through the drive pulley 125. Also attached to the drive shaft is a set of rubber drive transport rollers 124. These drive transport rollers 124 form a surface onto which the glass or ceramic substrate 113 may be transported through the IPS 100 (see FIG. 2). In one embodiment, these rollers are foamed or insulated to minimize heat transport away from the substrate. The rollers can be solid across the width of the machine (i.e. continuous rollers). They may also be discreetly placed in a random or staggered order to minimize heat loss from the glass being concentrated in a given machine direction lane. The rollers are ideally elastomers so that they have a high coefficient of friction (>1) with the glass or ceramic substrate they transport. Once the decal 114 has been properly positioned on substrate 113, the in-feed conveyor 110 then feeds substrate 113 to heating conveyor 120, wherein step 204 is performed.

Heating Substrate

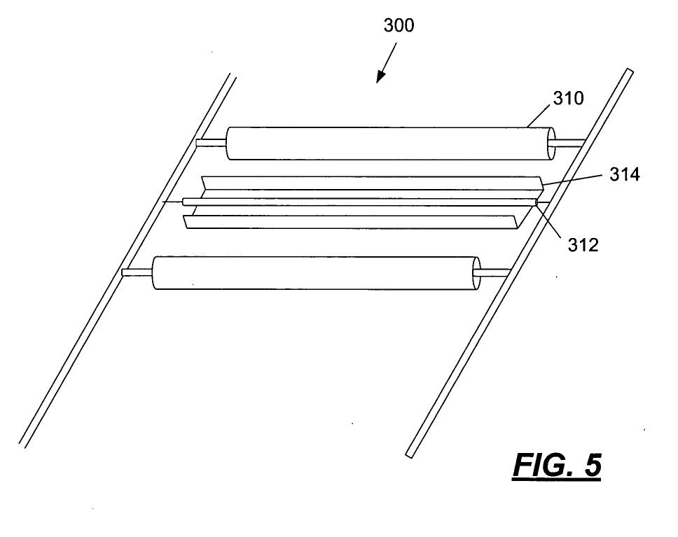

With reference to FIG. 1, and step 204 of process 200 depicted therein, the substrate is heated to a predetermined temperature. Any suitable means for heating the substrate may be used. For example, and as depicted in FIG. 5, the substrate (not shown) may be placed in a heating apparatus 300. Heating apparatus 300 is comprised of continuous rollers 310, heating elements 312 and heat reflection shield 314. In one embodiment, heating elements 312 are infrared (IR) heating lamps. Reference may be had to U.S. Pat. Nos. 4,658,716 Boissevain (Infrared Heating Calender Roll Controller); 5,966,836 to Valdez (Infrared Heating Apparatus and Method for a printing Press); 4,257,172 to Townsend (Combination Forced Air and Infrared Dryer); 4,716,658 to Jacobi (Heat Lamp Assembly); and the like. The content of each of the aforementioned patents is hereby incorporated by reference into this specification. In the embodiment depicted, continuous rollers 310 are configured such they uniformly withdraw heat from the substrate (not shown).

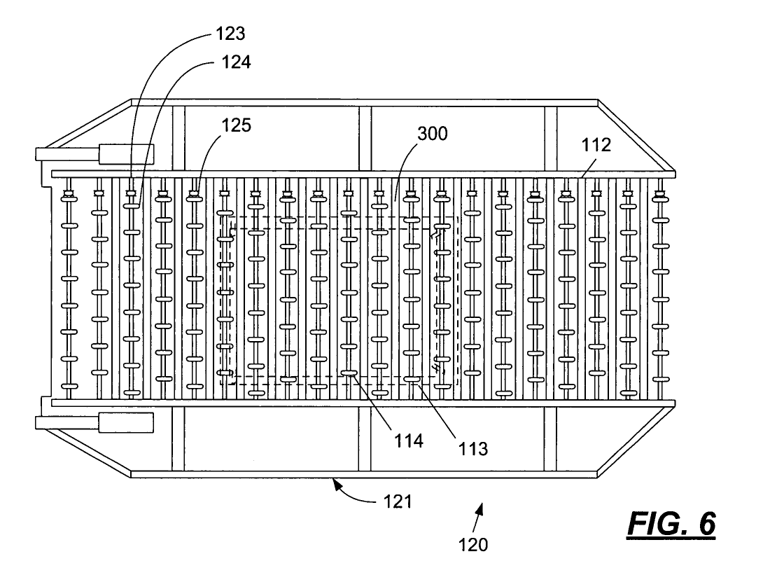

It is believed that a glass or ceramic substrate is a substantial heat sink and it is difficult to hot laminate a decal to a cold substrate with a heated roll laminator. Such cold substrates require a slow lamination speed for proper heat transfer. In one embodiment, this is accomplished by the appropriate choice of adhesive (generally thicker, with the ability to quickly melt, wet, and adhere to the glass) and laminating conditions (high pressure, slow speed). In another embodiment, the rollers are staggered (as in FIG. 6), rather than continuous (as in FIG. 5). Since the rollers 124 are cooler than the substrate itself, when the substrate contacts the rollers, the substrate is cooled somewhat. In this manner, the rollers 124 function as heat sinks. To prevent localized cooling, it is advantageous to expose the substrate to the rollers 124 in a consistent fashion (i.e. either a continuous roller or staggered rollers). Should the rollers not be staggered, the cumulative cooling effect of unstaggered rollers often results in temperature non-uniformity that produces image defects in the final imaged substrate.

It is advantageous to heat the substrate to a temperature above the softening point of the heat activatable material, typically 185° F. to 215° F. One method to evenly heat the substrate is to shuttle the substrate back and forth over the heaters to produce uniform heat. In one embodiment, only the bottom side of the substrate is directly heated. Heat is allowed to diffuse through the substrate from the bottom side to the top side, thus indirectly heating the top side. The heat diffusion that occurs during the shuffling process promotes uniform heating of the top side of the substrate, upon which the decal rests. Such shuffling processes are described in detail elsewhere in this specification. For thicker substrates is it preferred to use longer heating times. For thinner substrates is it preferred to use shorter heating times. One preferred method is to have direct radiation from below heat the substrate that, in turn, heats the decal. This may be accomplished using Unitube lamps available from Casso-Solar Corporation (Pomona, N.Y.). Other methods of heating (forced hot air, conductive heating, etc.) may also be used. Directly heating the decal, though, can induce significant curl, particularly if the decal is paper based, and could pose a barrier to heat transfer into the substrate. In one embodiment, the substrate is not irradiated from the top side. However, heating from the top may be permissible if the decal allows the energy to pass through to the substrate. It is preferable that the heating is performed in a manner that does not cause portions of the decal to adhere to the substrate prior to passing through the lamination nip. If such adhesion occurs, it can be difficult to remove all of the air trapped between the decal and the substrate; this can sometimes result in a non-uniformity in the fired image. When heating lamps are used, it is desirable to closely monitor the time and shuttling cycle to ensure uniform heating of the substrate. Staggering of transport rollers is also desirable for uniform substrate heating. Alternatively, or additionally, one may use continuous rollers. The thinner the substrate is the more desirable the use of staggered rollers or continuous rollers becomes.

FIG. 6 is an illustration of the heating conveyor 120 of FIG. 2, wherein step 204 of process 200 (see FIG. 1) is performed. Heating conveyor 120 is comprised of staggered rollers 124. The staggered rollers 124 are configured in such a way so as to promote uniform heating of the substrate (not shown) and avoid the formation of regions of localized coolness on the substrate. In the embodiment depicted, heating conveyor 120 is further comprised of safety guards 121, drive shaft 123, drive pulleys 125, and frame 112.

Referring again to FIG. 6, the substrate 113 and affixed decal 114 may be moved into the heating conveyor 120 section of the IPS 100 (see FIG. 2) by rotating the drive shafts 123. The heating conveyor 120 is composed of a similar set of drive shafts 123, drive pulleys 125 and rubber drive transport rollers 124 as the in-feed conveyor 110. The heating conveyor 120 of the IPS 100 is protected by a set of safety guards 121 attached to the IPS frame 112, keeping operators a safe distance away from this hot section of the machine. Interspersed between each drive shaft is heating apparatus 300. In one embodiment, heating apparatus 300 is comprised of IR lamps that are formed from long, cylindrical quartz bulbs, mounted between the frame members 112 of the heating conveyor 120. The reflection shield surrounds the lamps along the bottom and two sides of the quartz bulb, helping to reflect the thermal radiation upward toward the substrate 113 while minimizing heating of the rubber transport rollers 124. The lamps and shield are positioned such that they do not touch the rubber drive transport rollers 124 and are just below the surface formed by these rollers on which the substrate 113 rests. As the substrate 113 and affixed decal 114 are translated into the heating conveyor 120, the heating apparatus 300 is energized so as to begin the heating process. The substrate 113 and affixed decal 114 are shuttled, back and forth through the heating conveyor 120 by first rotating the drive shafts in one direction and then reversing the direction. This is done to ensure that the substrate is evenly heated. The details of such a shuttling process are discussed elsewhere in this specification. An IR temperature sensor (not shown) is mounted in the heating conveyor 120 and senses the temperature of the substrate 113 and affixed decal 114. Reference may be had to U.S. Pat. Nos. 6,007,242 to Uehashi (Infrared Temperature Sensor for a Cooking Device); 6,926,440 to Litwin (Infrared Temperature Sensors for Solar Panel); 5,169,234 to Bohm (Infrared Temperature Sensor); and the like. The content of each of the aforementioned patents is hereby incorporated by reference into this specification. The temperature of the substrate 113 and affixed decal 114 should be matched to the softening point of the heat activatable layer or substances in the frit ink. This temperature is often in the range 50° C. to 180° C. Ideally it is in the range of 80° C. to 100° C.

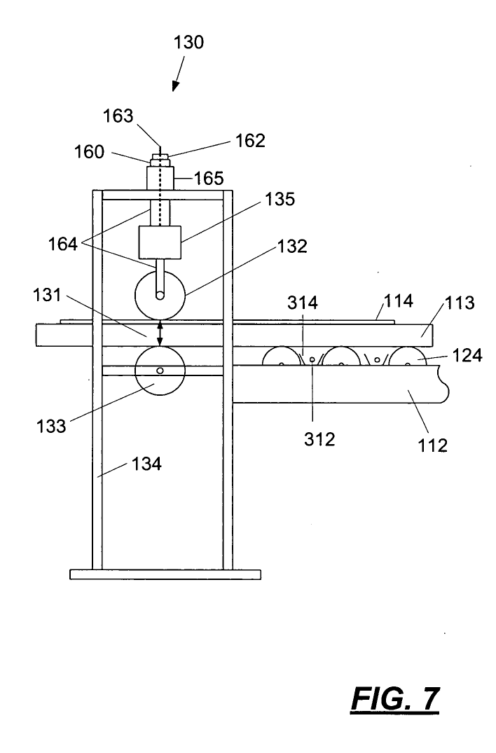

Referring again to FIG. 6, the substrate 113 and decal 114 are laminated in nip/laminator assembly 130 (see FIG. 2 and FIG. 7), as described elsewhere in this specification.

Laminate the Decal to the Substrate

With reference to FIG. 1, and step 206 of process 200 depicted therein, the substrate is laminated to the decal. Any suitable means of lamination may be used. In one embodiment, it is preferred to laminate the decal and substrate with a very thin heat transfer adhesive layer. In such an embodiment, it is preferred that the substrate be heated first. The image is then passed through the lamination nip to permanently attach the image to the substrate. In one embodiment, the lamination rollers are at ambient temperature. One such lamination means is depicted in FIG. 7.

FIG. 7 is an illustration of nip/laminator assembly 130 which is comprised of nip 131, lower roller 133, upper roller 132, rollers 124, heating elements 312, heat reflection shield 314. Upper roller 132 is in mechanical communication with air cylinder 135, which functions so as to apply pressure to the lower rollers 133 and upper rollers 132, thus forming nip 131 between rollers 132 and 133. Air cylinder 135 is comprised of shaft 164, annular ring 160, threaded bolt 163, a threaded nut 162 and mechanical stop 165. Also illustrated in FIG. 7 is substrate 113, upon which decal 114 has been disposed. In the embodiment depicted, substrate 113 and decal 114 are disposed in nip 131. As would be apparent to one skilled in the art, substrates of various thicknesses may be accommodated for by adjusting the gap of nip 131. This can be accomplished with annular ring 160, disposed between mechanical stop 165 and threaded nut 162, which controls the length of the gap of nip 131.

Referring again to FIG. 7 the nip/laminator assembly 130 is comprised of a set of nip rollers 132-133 attached to a laminator frame 134. Upper roller 132 may be moved up and down by means of pneumatic air cylinder 135 mounted between the frame 134 and the upper roller 132. The air cylinder 135 pushes the upper roller 132 downward so that it comes into contact with the decal 114 and substrate 113, forming a nip with the bottom nip roller 133. The pressure range in this lamination nip 131 may be between 25 to 1000 psi, ideally is 50 to 500 psi—more ideally is 200 to 500 psi. Upper roller 132 may be 1″ in diameter or larger. Ideally it is 3″ to 9″ in diameter. The top nip roller 132 durometer in the range of 10 Shore A to 100 Shore A, ideally the Shore A durometer is 45. The lower roller 133 durometer is in the range of 30 Shore A to 100 shore D. Ideally, the durometer is 65 Shore A. When substrate 113 and affixed decal 114 pass through the nip/lamination assembly 130, the upper roller 132 is compressed against the decal 114 and substrate 113 and deformed. The width of this deformation is called the footprint. The footprint should be greater than 1 millimeter in width. Ideally the footprint should be greater than 5 millimeters and more ideally greater than 10 millimeters in width. The speed at which substrate 113 and affixed decal 114 pass though the nip/lamination assembly 130 is in the range 2.5 centimeters per minute to 25 meters per minute. Ideally, the speed is 1 meter per minute. As the substrate 113 and decal 114 pass through the nip/lamination assembly 130, any air between the decal 114 and substrate 113 is squeezed out, allowing the imaged covercoat side of the decal to come in intimate contact with the surface of the substrate 113 and adhesively bond to this surface. Once the substrate 113 and affixed decal 114 have passed through the nip/lamination assembly 130, they are moved into the cooling conveyor 140 (see FIG. 2).

Cooling

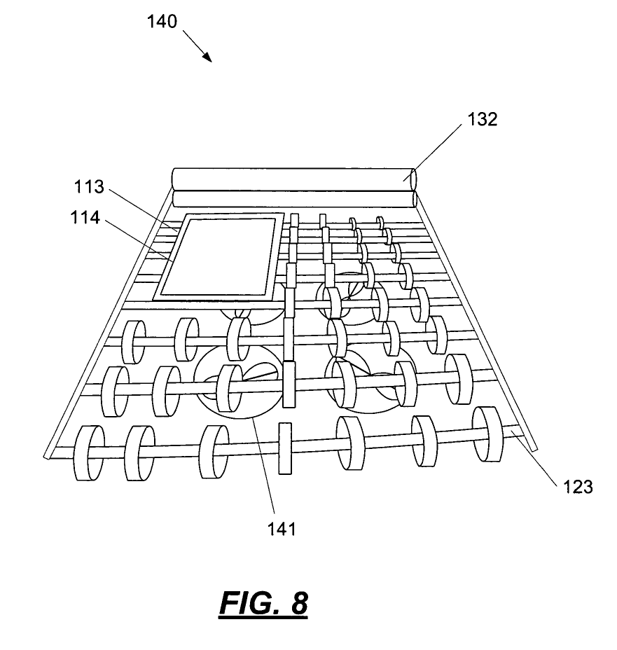

With reference to FIG. 1, and step 208 of process 200 depicted therein, the substrate and image are cooled. Any suitable means of cooling may be used. It should be appreciated that cooling step 208 is optional. In one embodiment, the cooling is a series of fans. A detailed depiction of cooling conveyor 140 is given in FIG. 8.

As shown in FIG. 8, the cooling conveyor 140 is composed of a similar set of drive shafts 123 and rubber drive transport rollers 124. The substrate 113 and laminated decal 114 are moved over one or more cooling fans 141 and allowed to cool. The temperature of the substrate 113 and laminated decal 114 is allowed to fall into a range at which the decal backing support may be peeled away from the imaged covercoat. Ideally, the backing can be peeled away at any temperature. However, the image may be more easily damaged at higher temperatures. Allowing the composite to cool before peeling is preferred. The peeling temperature is typically below 120° C. Ideally, it is below 100° C. More ideally it is below 50° C. The substrate 113 and laminated decal 114 can either be slowly cooled or more quickly cooled with fans 141 or with forced air or some other means. Once the substrate and decal have been cooled to a predetermined temperature, the decal backing support is removed.

Remove Flexible Decal Backing Support

With reference to FIG. 1, and step 210 of process 200 depicted therein, the flexible decal backing support is removed. Any suitable means of removal may be used. The decal backing sheet may be removed from the substrate by peeling a corner away at a consistent angle between 5 degrees and 180 degrees. The sheet can be peeled at speeds from 1 millimeter per second to 1 meter per second. The sheet may also be removed mechanically with take up tape as disclosed in previous applications.

Shuttling Processes

Uniform heating of the decal and substrate is highly desirable for hot lamination processes. Several heating methods can be used to ensure that uniform heating of the substrate and decal are achieved. Several such methods are described in FIG. 9 to FIG. 14C.

One such process of shuttling the substrate back and forth over the heaters to produce uniform heat is illustrated in FIGS. 9A and 9B. As shown in FIG. 9A, substrate 113, which has a top side and a bottom side, is shuttled over rollers 124 until edge 113A is detected by sensor 450. It is clear that the substrate 113 is comprised of heated section 113B and unheated section 113C. The heating elements 312 cause section 113B to be heated. Since section 113C is disposed over transporter 124, section 113C is an unheated section. In the embodiment depicted, a plurality of heating elements are used, wherein transporters (e.g. rollers 124) are disposed between each of the heating elements such that the bottom side of substrate 113 is contiguous with the transporter. To promote uniform heating, the direction of the roller 124 is reversed, and the substrate 113 moves until edge 113A is detected by sensor 451. Thereafter, section 113B is exposed to heating element 312 and becomes heated. This shuttling process may be repeated until the substrate 113 achieves the desired uniform temperature. The temperature uniformity across the surface of the substrate 113 and decal 114 should be no greater than 30° C. ideally no greater than 15° C. and more ideally no greater than 5° C. Once the desired temperature is achieved, the substrate 113 and decal are translated into the nip/laminator assembly 130.

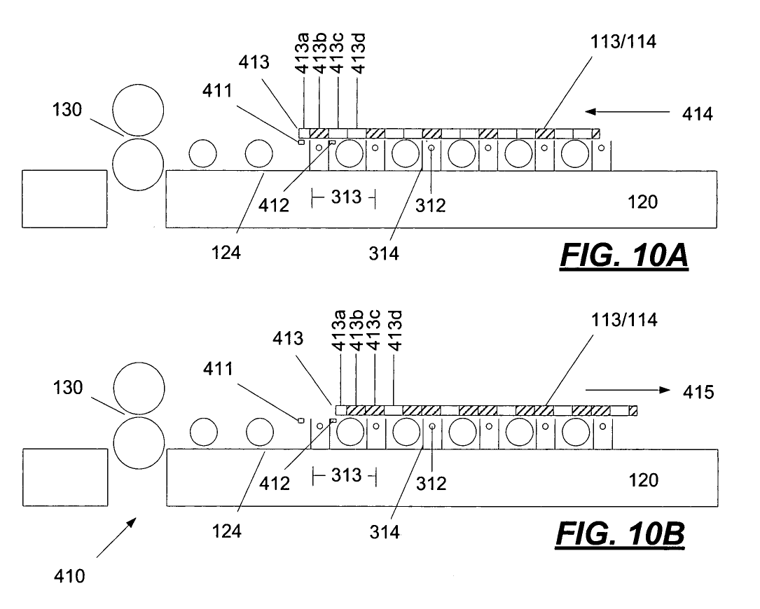

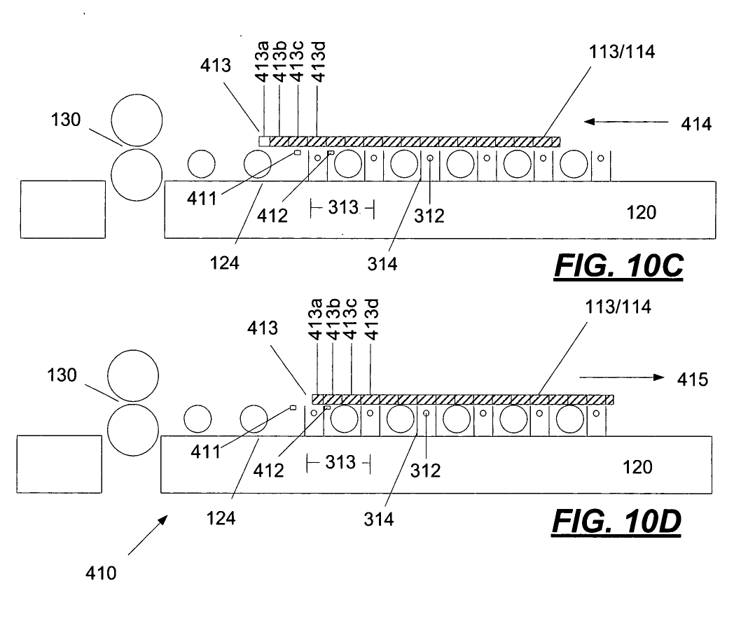

FIG. 9C generally depicts step 204 of process 200 (see FIG. 1) wherein the substrate is heated to a uniform temperature. In sub-step 902 of step 204, the substrate is disposed over the heating elements such that a first section of the substrate is over the heating elements and a second section is not disposed over heating element. In the embodiment depicted in FIG. 9A and 9B, the first section is heated section 113B and the second section is unheated section 113C. In FIGS. 9A and 9B, the substrate is heated from the bottom side of the substrate. Thereafter, and with reference to FIGS. 9A, 9B and 9C, the transporter 124 transports the substrate in a first direction in sub-step 906 of FIG. 9C. The substrate is transported in such a manner that the first section, now heated, is not disposed over a heating element, and the second section is now disposed over a heating element. In one embodiment, the first section is disposed over transporter 124. Since transporter 124 functions as a heat sink, the temperature of the first section may be reduced somewhat by exposure to the transporter 124. In sub-step 908 of step 204, the second section of the substrate, which is now disposed over a heating element, is heated. Thereafter, and in sub-step 910 of FIG. 9C, the heat radiates from the bottom side of the substrate to the top side of the substrate. It should be appreciated that it is not necessary to pause to allow such a diffusion of heat to take place. The heat transfer will continue to occur as the remaining sub-steps of step 204 are performed. Once both the first and section sections of the substrate have been exposed to the heating elements, sub-step 912 is performed, wherein the temperature of the substrate is checked to see if it has reached a predetermined value. Any suitable means for monitoring the temperature can be used. For example, one may use the infrared temperature sensors discussed elsewhere in this specification. Alternatively, or additionally, one may simply continue the shuttling process for a predetermined amount of time, and thus control the final temperature by controlling the exposure time. If the substrate has reached the desired temperature, then the lamination steps are conducted in accordance with step 206 (see FIG. 1). If the desired temperature has not been reached, then sub-step 914 is preformed. In sub-step 914, the substrate is transported in a direction opposite of the first direction such that the substrate is returned to its original position. In other words, after sub-step 914 has been executed, the first section is re-disposed over the heating elements and the second section is not disposed over a heating element, thus sub-step 914 can be repeated. This cycle continues until the substrate obtains the predetermined temperature. The precise details of the shuttling process may be varied so as to obtain a highly uniform temperature. This details are illustrated in FIG. 10A to FIG. 14C.

Referring to FIG. 10A “a Short Cycle—Leading Edge No. 1 substrate shuttling process” 410 is shown. The substrate 113 with the image decal 114 is fed into the heating/shuttle conveyor 120 in a forward direction 414 in this step 419 of the process. Substrate 113 is comprised of four repeating sections, 413a, 413b, 413c, and 413d. Once the leading edge 413 of the substrate 113 reaches first position sensor 411 the heating elements 312 turn on and heats second section 413b. The conveyor then reverses the direction of motion, thus causing substrate 113 to travel in a reverse direction 415 (see FIG. 10B).

Referring to FIG. 10B, the leading edge 413 of the substrate 113 now reaches second position sensor 412 in this step of the shuttling process and heats third section 413c. The conveyor reverses the direction of motion and begins traveling in forward direction 414 (see FIG. 10C).

Referring to FIG. 10C, the leading edge 413 of the substrate 113 reaches first position sensor 411 and continues forward ¼ the distance 313 between the heating elements 312 in this step of the process. The heating elements 312 then heat fourth section 413d. The conveyor then reverses the direction of motion, proceeding in a reverse direction 415 (see FIG. 10D).

Referring to FIG. 10D, the leading edge 413 of the substrate 113 again reaches first position sensor 411 and continues in the reverse direction ¼ the distance 313 between the heating elements in this step of the process. Heating elements 312 then heat first section 413a. The conveyor then reverses direction, proceeding in forward direction 414.

Referring again to FIGS. 10A to 10D, this cycle continues to repeat until the substrate 113 with the image decal 114 reaches the predetermined temperature. Once this predetermined temperature is reached the heating elements 312 are shut off and the conveyor moves in the forward direction 414. Thereafter, the substrate with the image decal passes through the nip laminator assembly.

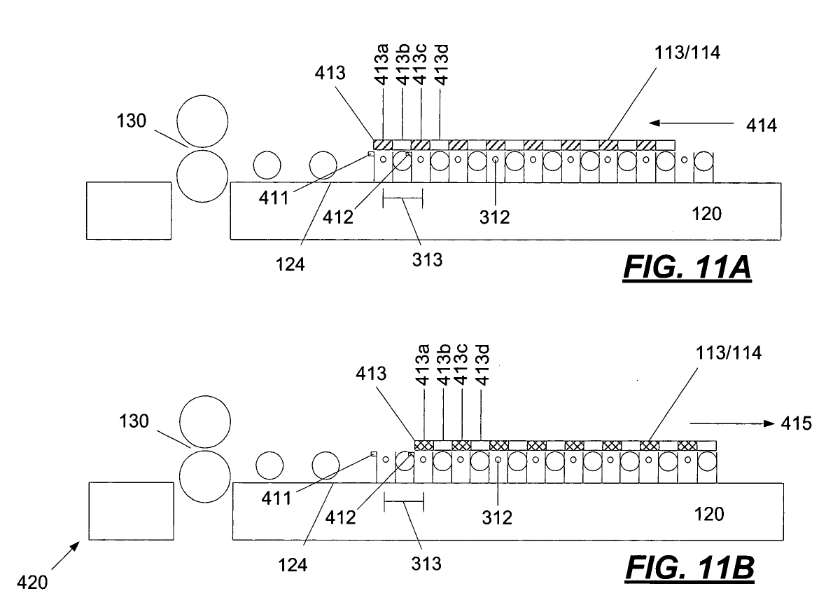

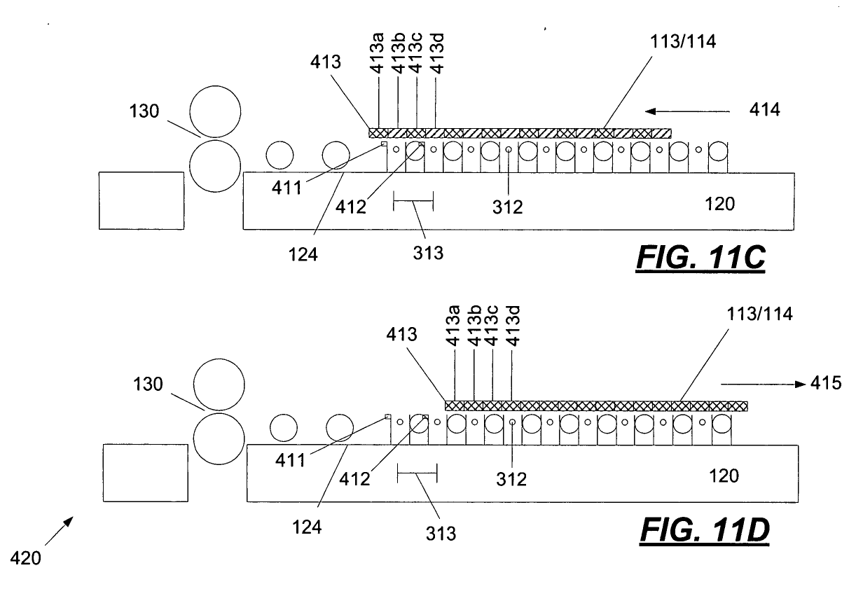

Referring to FIG. 11A a “Short Cycle—Leading Edge No. 2 substrate shuttling process” 420 is shown. The substrate 113 with the image decal 114 is fed into the heating conveyor 120 in this step of the process. Once the leading edge 413 of the substrate 113 reaches first position sensor 411 the heating elements 312 turn on and the conveyor reverses the direction of motion, thus traveling in reverse direction 415 (see FIG. 11B).

Referring to FIG. 11B, the leading edge 413 of the substrate 113 now reaches second position sensor 412 in this step of the process and the conveyor reverses the direction of motion and proceeds in a forward direction 414 (see FIG. 11C).

Referring now to FIG. 11C, the leading edge 413 of the substrate 113 reaches first position sensor 411 and continues forward ½ the distance 313 between the heating elements 312 in this step of the process and then the conveyor reverses the direction of motion and proceeds in a backwards direction 415 (see FIG. 11D).

Referring to FIG. 11D, the leading edge 413 of the substrate 113 again reaches second position sensor 412 and continues in the reverse direction ½ the distance 313 between the heating elements 312 in this step of the process 420. The conveyor then reverses direction and proceeds in a forward direction 414.

Referring again to FIGS. 11A to 11D, this cycle continues to repeat until the substrate 113 with the image decal 114 reaches the predetermined temperature.

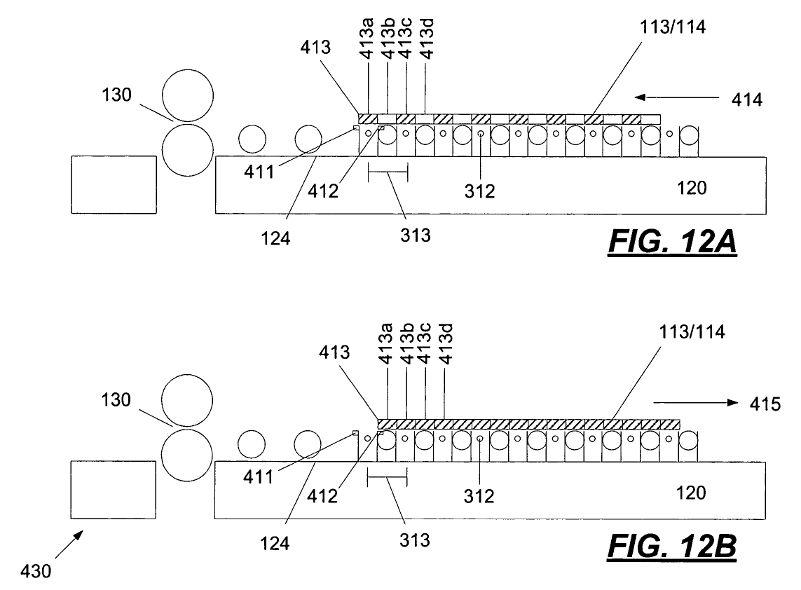

Once this predetermined temperature is reached the heating elements 312 are shut off and the conveyor moves in the forward motion 414. The substrate 113 with the image decal 114 goes through the nip laminator assembly 130. Referring to FIG. 12A “a Short Cycle—Leading Edge No. 3 substrate shuttling process” 430 is shown. The substrate 113 with the image decal 114 is fed into the heating conveyor 120 in this step of the process. Once the leading edge 413 of the substrate 113 reaches first position sensor 411 the heating elements 312 turn on and the conveyor reverses the direction of motion, proceeding in a backward direction 415 (see FIG. 12B).

Referring to FIG. 12B, the leading edge 413 of the substrate 113 now reaches second position sensor 412 in this step of the process and the conveyor reverses the direction of motion 414 and now proceeds in a forward direction.

This cycle continues to repeat until the substrate 113 with the image decal 114 reaches the predetermined temperature. Once this predetermined temperature is reached the heating elements 312 are shut off and the conveyor reverses direction or continues in the forward direction 414. The substrate 113 with the image decal 114 then proceeds into the nip laminator assembly 130.

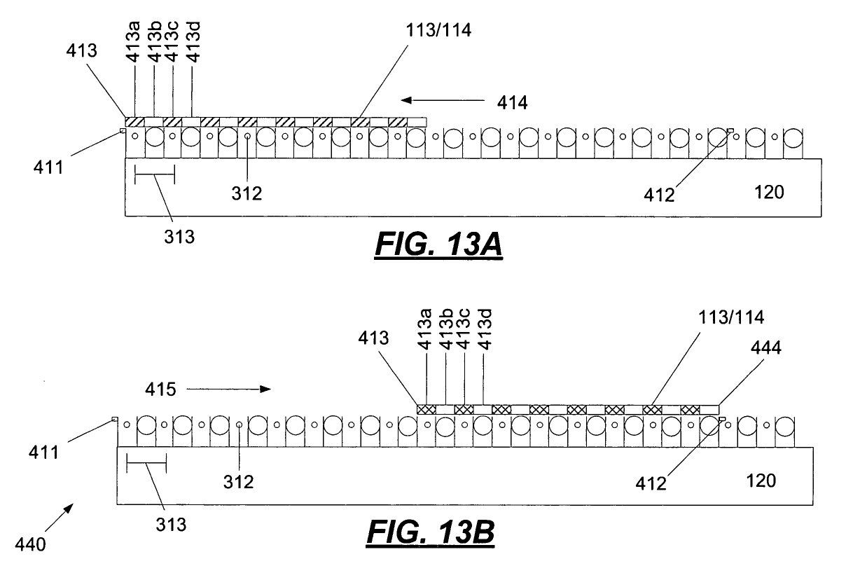

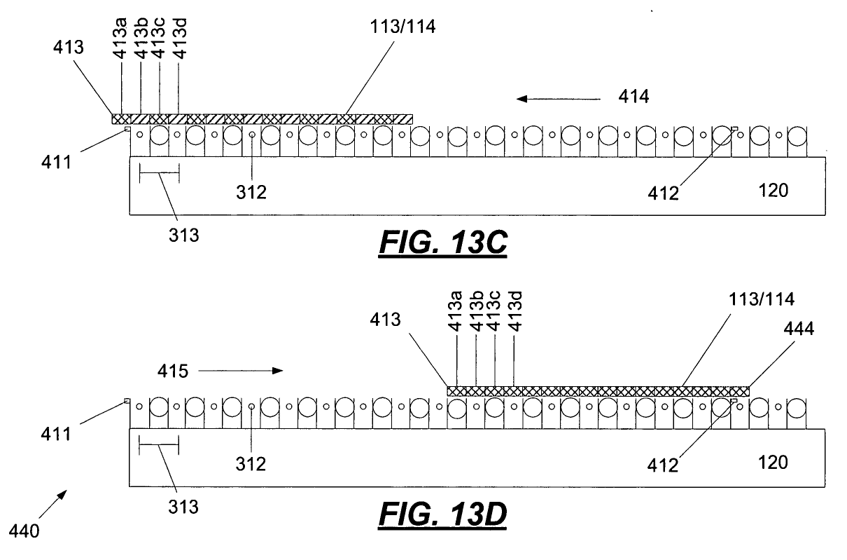

Referring to FIG. 13A a “Long Cycle—Leading Edge/Trailing Edge No. 1 substrate shuttling process” 440 is shown. The substrate 113 with the image decal 114 are fed into the heating conveyor 120 in this step of the process. Once the leading edge 413 of the substrate 113 reaches first position sensor 411 the heating elements 312 turn on and the conveyor reverses the direction of motion, proceeding in a backward direction 415 (see FIG. 13B).

Referring to FIG. 13B, the trailing edge 444 of the substrate 113 now reaches second position sensor 412 in this step of the process and the conveyor reverses the direction of motion and proceeds in a forward direction 414 (see FIG. 13C).

Referring to FIG. 13C, the leading edge 413 of the substrate 113 reaches first position sensor 411 and continues forward ½ the distance 313 between the heating elements 312 in this step of the process and then the conveyor reverses the direction of motion, proceeding in a backward direction 415 (see FIG. 13D).

Referring to FIG. 13D, the trailing edge 444 of the substrate 113 reaches position second sensor 412 and continues backward ½ the distance between the heating elements 312 in this step of the process and then the conveyor reverses the direction of motion and proceeds in a forward direction 414.

Referring again to FIGS. 13A to FIG. 13D, this cycle continues to repeat until the substrate 113 with the image decal 114 reaches the predetermined temperature. Once this predetermined temperature is reached the heating elements 312 are shut off and the conveyor moves in the forward direction 414. The substrate with the image decal proceeds into the nip laminator assembly 130 (see FIG. 8).

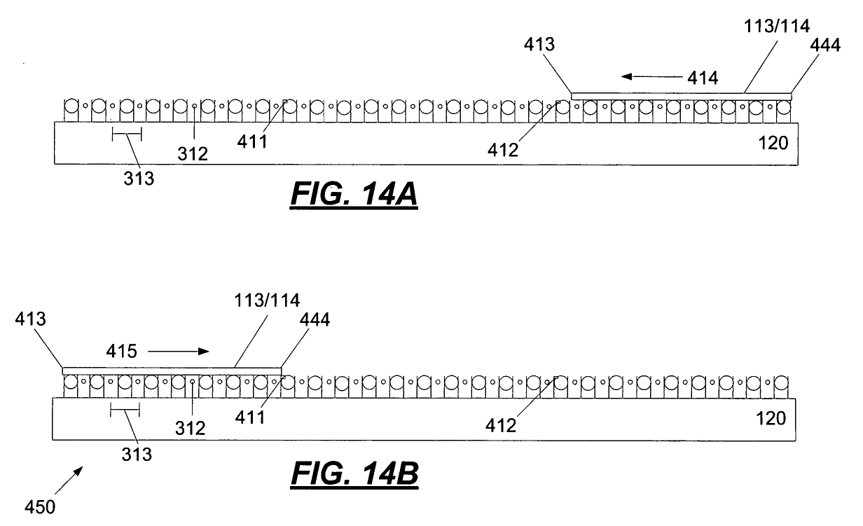

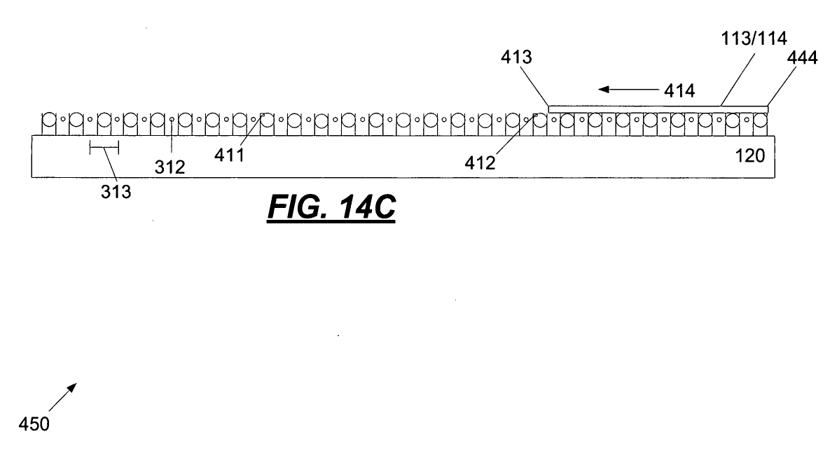

Referring to FIG. 14A a “Long Cycle—Leading Edge/Trailing Edge No. 2 substrate shuttling process” 460 is shown. The substrate 113 with the image decal 114 is fed into the heating/shuttle conveyor 120 in this step of the process. Once the leading edge 413 of the substrate 113 reaches second position sensor 412 the heating elements 312 turn on and the substrate 113 with the image decal 114 passes across the heating conveyor 120 in a forward direction 414. Referring to FIG. 14B after the substrate 113 with the image decal 114 passes over second position sensor 412, the trailing edge 444 of the substrate 113 passes over first position sensor 411. The conveyor then reverses the direction of motion and proceeds in a backward direction 415.

Referring to FIG. 14C, the substrate 113 with the image decal 114 travels across the heating conveyor 120 in this step of the process. Once the leading edge 413 of the substrate 113 passes second position sensor 412, the conveyor then reverses the direction of motion and proceeds in a forward direction 414.

Referring again to FIG. 14A to FIG. 14C, this cycle continues to repeat until the glass panel 113 with the image decal 114 reaches the predetermined temperature.

Once this predetermined temperature is reached the heating elements 312 are shut off and the conveyor reverses direction or continues in the forward motion 414. The substrate 113 with the image decal 114 proceeds into the nip laminator assembly 130 (see FIG. 2).

An alternate process involved first heating of the substrate, using an imaging positioning tray mechanism to position the decal onto the substrate prior to lamination.

Another Assembly for use with Process 200

In one embodiment, the decal is positioned on the substrate and the substrate is thereafter heated. Such a configuration is desirable when the decal is manually affixed. In another embodiment, the decal is automatically affixed with an image positioning tray assembly. In such an embodiment, the decal may easily be affixed while the substrate is hot.

Overview of Image Positioning Tray:

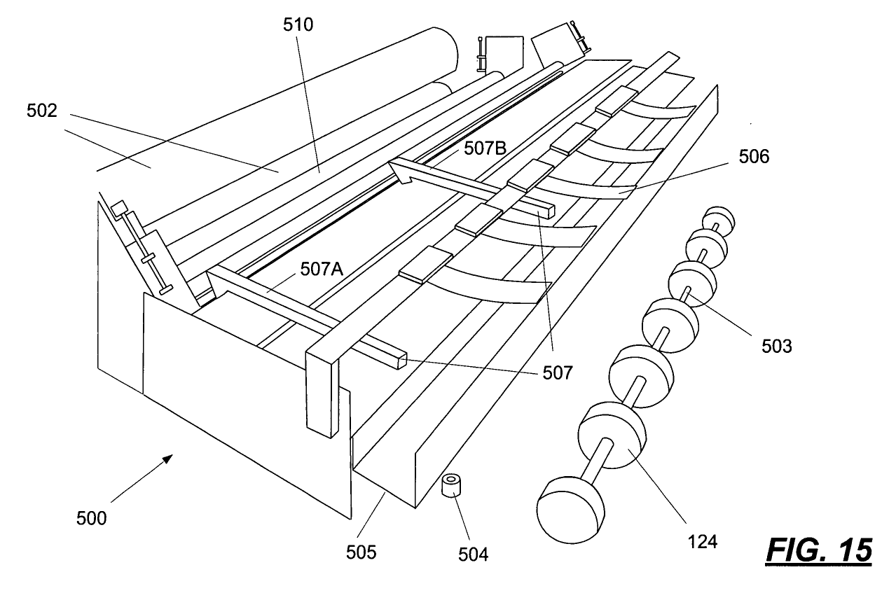

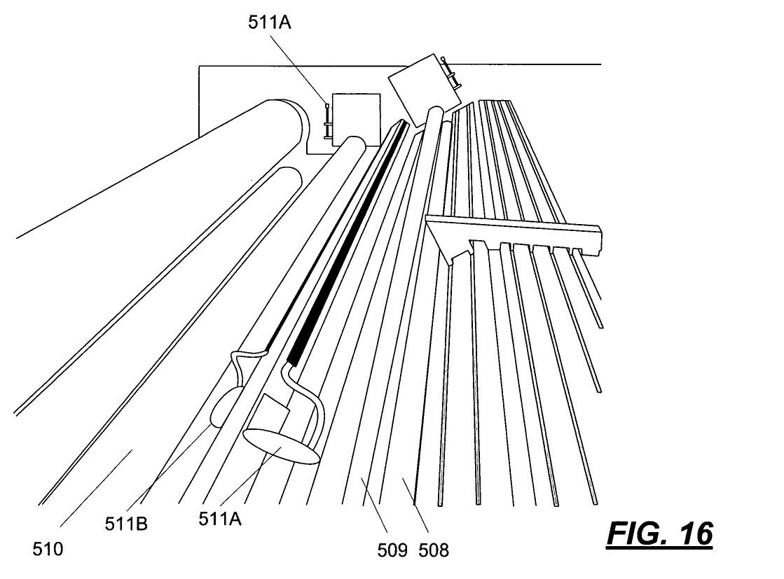

FIG. 15 and FIG. 16 will be used to illustrate each component of the tray mechanism as the system is explained in the following paragraphs. The tray mechanism provides a technique to accurately and automatically locate a flexible substrate such as imaged paper to a rigid panel such as glass. The design features a very flexible concept for handling a wide variety of flexible substrate and rigid panel widths and lengths. This tray mechanism 500 shown in FIG. 15 works in conjunction with rollers 124 and nip rollers 502 that makes up the entire system. The substrate can be made of paper, polyethyleneterephthalate (PET) film or other flexible material. The panel can be made from glass, wood, plastic or other rigid materials.

Mode of Operation

With reference to FIG. 14, the decal (not shown) is placed in the tray mechanism 500 and held in place between two adjustable guide rails 507, then automatically moved to a predetermined location awaiting application to the substrate. The substrate is moved by rollers 124 to a predetermined location, using an edge guide 504 to maintain proper orientation with the decal. When the system is energized, the substrate begins to move while an application roller 510 applies the leading edge of the imaged paper to the substrate. Then, as the substrate continues to move through two nip rollers 502, the pressurized nip roller bonds the decal accurately to the substrate.

The following examples are with reference to FIG. 15 and FIG. 16.

Example of Sequence of Steps and Components:

Referring now to FIG. 15, the proximal adjustable guide rail 507A is moved laterally to an appropriate scale indicator position which determines the proper width orientation on the glass, then locked into place.

The decal is rolled up along its width, to create a tube-type shape with an approximate diameter of about two to three inches. The rolled up decal is then place in U-shaped cavity 505. Such a configuration provides flexibility to handle a large variation in decal width and lengths.

The decal leading edge is then moved to a location under the first sensor 511A of FIG. 16. As one edge of the decal is placed against the proximal adjustable guide rail 507A, the distal adjustable guide rail 507B is placed against the other edge of the decal and locked into position. These guide rails serve to keep the decal in correct alignment with the substrate as both items move through the nip roller assembly. The adjustable nature of these guide rails 507 provides flexibility to handle a wide variety of decal widths and orientations.

Pressure fingers 506 are then rotated into position to keep the decal flat against the tray mechanism base. Pressure fingers 506 help maintain correct and accurate orientation of the decal on the substrate.

When the system is energized, the decal is automatically moved to a lower sensor position 511B by the image feed roller 508 and advance roller 509. Maintaining the proper relationship between the decal and application roller 510 is desirable to promote accurate placement on the substrate. Otherwise the decal leading edge may be misaligned with the substrate leading edge.

As the power conveyor 503 is energized, the substrate is automatically moved to a pre-determined location, using the conveyor edge guide 504 to maintain proper alignment with the decal.

At this point in time both the decal and substrate are poised in proper location and awaiting a signal from the control system (not shown). When the system is energized, the substrate begins to move forward as the applicator roller 510 moves downward bringing the decal to the substrate. These motions are timed within the system to accurately align the decal and substrate.

When the decal leading edge is brought in contact with the substrate, the image feed rollers 508 and advance rollers 509 are automatically opened. This design feature is desirable to promote system timing and proper decal alignment relative to the substrate.

Substrate and decal continue to move through the nip rollers 502 and are then laminated by the pressure of the nip rollers.

During installation of the tray mechanism special fixtures have been designed to properly align all components of the system. It is advantageous that nip rollers 502, application roller 510, image feed roller 508 and advance roller 509, adjustable guide rails 507, conveyor edge guide 504, powered conveyor 503, U-shaped cavity 505, should all be in proper alignment.

Since the decal and substrate are being moved between rollers, any pressure differential within the nip point of these rollers can cause misalignment. Micrometer adjustments 512 are designed on each end of the application roller 510 and image advance roller 509. These micrometers allow precise adjustment of the nip gap.

It is therefore, apparent that there has been provided, in accordance with the present invention, a method and apparatus for uniformly heating a substrate and uses therefore. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

I claim:

1. A method for uniformly heating a substrate, comprising the steps of;
a. disposing a substrate with a top side and a bottom side over a surface wherein said surface is comprised of a first heating element, a second heating element, and a transporter disposed between said first and second heating elements such that said bottom side is contiguous with said transporter;
b. subjecting said substrate to a first heat treatment process, comprising the steps of sequentially;
i. irradiating said bottom side of said substrate with said first heating element and said second heating element, thus producing a first heated bottom section above said first heating element and a second heated bottom section above said second heating element and an unheated bottom section above said transporter, whereby a first heated substrate is produced; and
ii. transporting said first heated substrate with said transporter in a first direction across said surface such that said unheated bottom section is disposed over said second heating element and said first heated bottom section is disposed over said transporter;
c. subjecting said first heated substrate to a second heat treatment process, comprising the steps of sequentially;
i. irradiating said bottom side of said first heated substrate with said first heating element such that said unheated bottom section becomes heated to produce a third heated bottom section wherein said first, second, and third heated bottom sections have about the same temperature, whereby a second heated substrate is produced; and
ii. transporting said second heated substrate in a second direction, opposite to said first direction, across said surface such that said first heated bottom section is disposed over said first heating element and said third heated bottom section is disposed over said transporter; and
d. allowing heat to radiate from said first, second, and third heated bottom sections of said second heated substrate to said top side of said second heated substrate, such that said top side achieves a uniform temperature with a temperature uniformity of less than about 30 degrees Celsius;
e. repeating said first heat treatment process, said second heat treatment process, and said step of allowing heat to radiate until said top side reaches a predetermined temperature between about 50 degrees Celsius to about 180 degrees Celsius.

2. The method for uniformly heating a substrate as recited in claim 1, wherein said transporter functions as a heat sink that cools said bottom side of said substrate.

3. The method for uniformly heating a substrate as recited in claim 2, wherein said transporter is a roller.

4. The method for uniformly heating a substrate as recited in claim 3, wherein said roller is a continuous roller.

5. The method for uniformly heating a substrate as recited in claim 3, wherein said roller is a staggered roller.

6. The method for uniformly heating a substrate as recited in claim 3, wherein said roller is an elastomeric roller with a coefficient of friction with said substrate of greater than 1.

7. The method for uniformly heating a substrate as recited in claim 1, wherein said first and second heating elements are infrared heating elements.

8. The method for uniformly heating a substrate as recited in claim 2, wherein said surface is further comprised of a second transporter disposed adjacent to said second heating element but not between said first heating element and said second heating element.

9. The method for uniformly heating a substrate as recited in claim 1, wherein said substrate is not irradiated from said top side.

10. The method for uniformly heating a substrate as recited in claim 1, wherein said substrate is selected from the group consisting of a glass substrate, a ceramic substrate, and combinations thereof.

11. The method for uniformly heating a substrate as recited in claim 1, wherein said temperature uniformity is less than about 15 degrees Celsius.

12. The method for uniformly heating a substrate as recited in claim 1, wherein said temperature uniformity is less than about 5 degrees Celsius.

13. The method for uniformly heating a substrate as recited in claim 11, wherein said predetermined temperature is from about 80 degrees Celsius to about 100 degrees Celsius.

14. The method for uniformly heating a substrate as recited in claim 1, wherein said surface is further comprised of a first position sensor for sensing the leading edge of said substrate, and a second position sensor for sensing the leading edge of said substrate.

15. The method for uniformly heating a substrate as recited in claim 14, wherein said first heating element is disposed between said first and second position sensors.

16. The method for uniformly heating a substrate as recited in claim 14, wherein said first heating element and said transporter are disposed between said first and second position sensors.

17. The method for uniformly heating a substrate as recited in claim 1, wherein said surface is further comprised of a first position sensor for sensing the leading edge of said substrate, and a second position sensor for sensing the trailing edge of said substrate.

18. The method for uniformly heating a substrate as recited in claim 17, wherein said first and second heating elements are disposed between said first and second position sensors.

19. The method for uniformly heating a substrate as recited in claim 1, wherein said surface is further comprised of a first position sensor for sensing the trailing edge of said substrate, and a second position sensor for sensing the trailing edge of said substrate.

20. The method for uniformly heating a substrate as recited in claim 19, wherein said first and second heating elements are disposed between said first and second position sensors.

21. A process for producing an imaged substrate, comprising the steps of;
a. positioning a decal on a substrate, wherein;
i. said decal is comprised of a flexible backing support with an image side and a back side, wherein said image side is comprised of digital image disposed beneath a heat activatable, pressure adhesive layer with a thermal activation threshold and a pressure activation threshold,;
ii. said substrate has a top side and a bottom side and is selected from the group consisting of a glass substrate, a ceramic substrate, and combinations thereof; and
iii. said image side of said decal is positioned on said top side of said substrate;
b. heating said bottom side of said substrate and allowing heat to radiate from said bottom side to said top side, thus uniformly heating said top side to a temperature above said thermal activation threshold of said adhesive layer such that said top side has a temperature uniformity of less than about 30 degrees Celsius;
c. applying a pressure greater than said pressure threshold to said decal while said top side is at a temperature greater than said thermal threshold such that said adhesive layer adheres said digital image to said substrate, thus producing a decal-substrate complex;
d. cooling said substrate after producing said decal-substrate complex; and
e. removing said flexible backing support from said decal-substrate complex such that said digital image is transferred to said substrate, thus producing an imaged substrate.

22. The process for producing an imaged substrate as recited in claim 21, wherein said step of uniformly heating said substrate is performed prior to said step of positioning said decal on said substrate.

23. The process for producing an imaged substrate as recited in claim 21, wherein said step of uniformly heating said substrate is performed subsequent to said step of positioning said decal on said substrate.

24. The process for producing an imaged substrate as recited in claim 21, wherein said step of positioning said decal on said substrate uses leading edge tape placed along the leading edge of said decal, thus creating a tension along said leading edge and trailing edge tape placed on the trailing edge of said decal, thus creating a diagonal tension.

25. An apparatus for producing an imaged substrate, comprising a transporter that is comprised of rollers selected from the group consisting of continuous rollers, staggered rollers, and combinations thereof, wherein said transporter is further comprised of;
a. an in-feed conveyor section for moving a substrate-decal assembly in a forward direction, wherein said substrate-decal assembly is comprised of a substrate and a decal, said substrate has a top side and a bottom side, and said decal is comprised of an image, a flexible backing support, and a heat activatable, pressure adhesive layer with a thermal activation threshold and a pressure activation threshold;
b. a heating conveyor section for receiving said substrate-decal assembly from said in-feed conveyor section, wherein said heating conveyor section is comprised of;
i. a first heating element and a second heating element configured to heat said bottom side of said substrate, wherein said rollers are disposed between said first heating element and said second heating element such that said bottom side of said substrate is contiguous with said rollers;
ii. a first heat shield and a second heat shield disposed about said first heating element and said second heating element respectively such that heat is directed away from said rollers and toward said bottom side of said substrate;
iii. a first position sensor for sensing the leading edge of said substrate and a second position sensor for sensing the trailing edge of said substrate;
iv. said transporter is configured to shuttle said substrate in said forward direction and in a reverse direction over said first and second heating elements such that said bottom side is uniformly heated to a predetermined temperature, and allow heat to radiate from said bottom side to said top side such that said top side has a temperature uniformity of less than about 30 degrees Celsius and said top side obtains said predetermined temperature, wherein said predetermined temperature is greater than said thermal activation threshold; and
c. a laminator assembly section for receiving said substrate from said heating conveyor section and applying a pressure to said substrate-decal assembly while said substrate-decal assembly is still at said predetermined temperature, thus adhering said image to said substrate, wherein said pressure is greater than said pressure activation threshold, and said transporter moves said substrate-decal assembly through said laminator assembly section, thus producing a decal-substrate complex.

26. The apparatus for producing an imaged substrate as recited in claim 25, wherein said transporter is further comprised of a cooling conveyor section for receiving said decal-substrate complex from said laminator assembly section.

27. The apparatus for producing an imaged substrate as recited in claim 26, wherein said cooling conveyor section is further comprised of a fan configured to direct air toward said decal-substrate complex.

28. The apparatus for producing an imaged substrate as recited in claim 25, further comprising a temperature sensor for monitoring the temperature of said substrate.

29. The apparatus for producing an imaged substrate as recited in claim 25, wherein said laminator assembly section is comprised of a lower roller, an upper roller and a nip formed between said upper roller and said lower roller, wherein the length of said nip is adjustable, wherein said pressure applied by said laminator assembly section is from about 25 pounds per square inch to about 1000 pounds per square inch.

30. The apparatus for producing an imaged substrate as recited in claim 29, wherein said pressure is from about 50 pounds per square inch to about 500 pounds per square inch.

31. The apparatus for producing an imaged substrate as recited in claim 29, wherein said pressure is from about 200 pounds per square inch to about 500 pounds per square inch.

32. The apparatus for producing an imaged substrate as recited in claim 25, wherein said upper roller has a Shore A durometer of from about 10 to about 100, and said lower roller has a Shore A durometer of from about 30 to about 100.

33. The apparatus for producing an imaged substrate as recited in claim 32, wherein the Shore A durometer of said upper roller is less than the Shore A durometer of said lower roller.

34. The apparatus for producing an imaged substrate as recited in claim 33, wherein, upon application of said pressure to said substrate-decal assembly, said upper roller deforms and produces a footprint greater than 1 millimeter.

35. The apparatus for producing an imaged substrate as recited in claim 34, wherein said footprint is greater than 10 millimeters.

36. The apparatus for producing an imaged substrate as recited in claim 25, wherein said substrate-decal assembly passes through said laminator assembly section at a speed of from about 2.5 centimeters per minute to about 25 meters per minute.

37. The apparatus for producing an imaged substrate as recited in claim 25, wherein said substrate-decal assembly passes through said laminator assembly section at a speed of from about 0.1 meters per minute to about 5 meters per minute.

38. A method for uniformly heating a substrate, comprising the steps of;
a. disposing a substrate with a top side and a bottom side over a surface wherein said surface is comprised of at least one heating element, and transporters disposed on both sides of said heating elements such that said bottom side of said substrate is contiguous with said transporters;
b. subjecting said substrate to a heat treatment process, comprising the steps of sequentially;
i. transporting said substrate in a first direction across said surface with said transporter;
ii. irradiating said bottom side of said substrate with said heating elements such that the entire bottom surface of said substrate receives a uniform dose of radiant energy; and
iii. allowing heat to diffuse from said bottom side to said top side of said substrate;
iv. transporting substrate with said transporter in a second direction, which is opposite said first direction, across said surface;
v. irradiating said bottom side of said substrate with said heating elements such that the entire bottom side of said substrate receives a uniform dose of radiant energy; and
vi. allowing heat to diffuse from said bottom side to said top side of said substrate;
vii. repeating steps i. to vi. until said top side of said substrate reaches a predetermined temperature between about 50 degrees Celsius to about 180 degrees Celsius with a temperature uniformity across said top side of less than about 30 degrees Celsius.

39. The method for uniformly heating a substrate as recited in claim 38, wherein said top side of said substrate is contiguous with a decal wherein said decal is comprised of a heat activatable, pressure adhesive layer with a thermal activation threshold and a pressure activation threshold, a digital image, and a flexible backing support;

40. The method for uniformly heating a substrate as recited in claim 39, wherein said transporters function as heat sinks that cool said bottom side of said substrate.

41. The method for uniformly heating a substrate as recited in claim 39, wherein said transporters are rollers.

42. The method for uniformly heating a substrate as recited in claim 41, wherein said rollers are continuous rollers.

43. The method for uniformly heating a substrate as recited in claim 41, wherein said rollers are staggered rollers.

44. The method for uniformly heating a substrate as recited in claim 41, wherein said rollers are elastomeric rollers with a coefficient of friction with said substrate of greater than 1.

45. The method for uniformly heating a substrate as recited in claim 39, wherein said heating elements are infrared heating elements.

46. The method for uniformly heating a substrate as recited in claim 39, wherein said substrate is not irradiated from said top side.

47. The method for uniformly heating a substrate as recited in claim 39, wherein said substrate is selected from the group consisting of a glass substrate, a ceramic substrate, and combinations thereof.

48. The method for uniformly heating a substrate as recited in claim 39, wherein said temperature uniformity is less than about 15 degrees Celsius.

49. The method for uniformly heating a substrate as recited in claim 39, wherein said temperature uniformity is less than about 5 degrees Celsius.

50. The method for uniformly heating a substrate as recited in claim 48, wherein said predetermined temperature is from about 80 degrees Celsius to about 100 degrees Celsius.

51. The method for uniformly heating a substrate as recited in claim 39, wherein said surface is further comprised of a first heating element and an adjacent first transporter and a last heating element and an adjacent last transporter, a first position sensor for sensing the leading edge of said substrate, and a second position sensor for sensing the leading edge of said substrate.

52. The method for uniformly heating a substrate as recited in claim 51, wherein said last heating element is disposed between said first and second position sensors.

53. The method for uniformly heating a substrate as recited in claim 51, wherein said last heating element and said adjacent last transporter are disposed between said first and second position sensors.

54. The method for uniformly heating a substrate as recited in claim 39, wherein said surface is further comprised of a first heating element and a last heating element, a first position sensor for sensing the leading edge of said substrate, and a second position sensor for sensing the trailing edge of said substrate.

55. The method for uniformly heating a substrate as recited in claim 54, wherein said last heating element is disposed between said first and second position sensors.

56. The method for uniformly heating a substrate as recited in claim 39, wherein said surface is further comprised of a first heating element and a last heating element, a first position sensor for sensing the trailing edge of said substrate, and a second position sensor for sensing the trailing edge of said substrate.

57. The method for uniformly heating a substrate as recited in claim 56, wherein said first and said second position sensors are disposed between said first and last heating elements.

58. The method for uniformly heating a substrate as recited in claim 39, wherein said surface is further comprised of one or more heat shields disposed between said heating elements and said transporters.

59. The method for uniformly heating a substrate as recited in claim 39, wherein one or more temperature sensors for sensing the temperature of the top side of said substrate are provided above said surface.

60. The method for uniformly heating a substrate as recited in claim 1, wherein said surface is further comprised of one or more heat shields disposed between said heating elements and said transporter.

61. The method for uniformly heating a substrate as recited in claim 1, wherein one or more temperature sensors for sensing the temperature of the top side of said substrate are provided above said surface.

62. The method for uniformly heating a substrate as recited in claim 39, further comprised of the step of laminating said decal to said substrate by applying a pressure greater than said pressure activation threshold to said decal and said substrate while said top side of said substrate is at a temperature greater than said thermal activation threshold such that said adhesive layer adheres said digital image to said substrate, thus producing a decal-substrate complex.

63. The method for uniformly heating a substrate as recited in claim 62, wherein said substrate is cooled to a temperature of less than about 30 degrees Celsius after producing said decal-substrate complex.

64. The method for uniformly heating a substrate as recited in claim 63, wherein said flexible backing support is removed from said decal-substrate complex such that said digital image is transferred to said substrate, thus producing an imaged substrate.
